(19) United States
(12) Patent Application Publication
(10) Pub. No.: US 2019/0066452 A1
(43) Pub. Date: Feb. 28, 2019

(54) CUSTOM DECK CARD GAME

(71) Applicant: Kathleen Nylund Jackson, Newport, NC (US)

(72) Inventor: Kathleen Nylund Jackson, Newport, NC (US)

(21) Appl. No.: 15/684,431

(22) Filed: Aug. 23, 2017

(51) Int. Cl. G07F 17/32

(52) U.S. Cl. CPC G07F 17/3293; G07F 17/3288; G07F 17/323; G07F 17/3267; G07F 17/3211; G07F 17/3262; G07F 17/3258

(57) ABSTRACT

A wagering card game utilizing at least one deck of custom cards has at least one player competing against a dealer. The object of the game in determining a win versus a loss is to achieve a hand with the greatest amount of cards possible without busting and to have a greater amount of cards in the player's hand than the dealer has in the dealer's hand at the game's conclusion. Awards are based upon the degree of the amount of cards in the player's hand exceeding the amount of cards in the dealer's hand as a multiple of a player wager. The custom card deck comprises value cards and action cards. The value cards are sequentially numbered, and marked by a special marking. The action cards do not have value but rather provide specific play directives.

### BACKGROUND OF THE INVENTION

### 1. Field of the Invention

The present invention relates to a card game suitable for use in casinos and other gaming establishments, as well as wagering or non-wagering spaces including websites and applications.

### 2. Background of the Art

Casinos regularly desire to obtain new games to maintain player interest and excitement. Although the traditional games of Blackjack (twenty-one), Bacarrat, and Poker (and its variants) have been staples at casinos, additional games have been regularly added for variety and stimulation. Variations of standard games such as blackjack have been introduced, with games such as 13—Over and Under (a side bet wager game) and Spanish Twenty-One™ enjoying some success. Many poker variants have been introduced, such as Let It Ride® poker, Caribbean Stud® poker, Three-Card™ poker, and the like. The benefits of these poker variant games include the fact that any number of players (up to the table limit and the cards available from the deck) may play games either against the dealer's hand or against a pay table. Even Casino War™ card game has achieved some level of play in casinos because it is easy to understand, competitive, and some extended play can be enjoyed at the table at moderate cost levels.

U.S. Pat. No. 7,185,891 (Jackson) teaches a wagering game that has a dealer compete against a player. The at least one player and the dealer receive a single card. The at least one player takes at least one mandatory hit card. If the at least one mandatory hit card has the specific relationship in rank to the single card, or if the at least one mandatory hit card allows the at least one player to continue the game, the player has the option of taking another hit card. When the player has elected to take no more hits or has taken a maximum number of hits, but has not taken a card that busts, the dealer taking at least one mandatory hit card the dealer taking hits until the dealer busts, until the dealer receives a predetermined maximum number of cards, or until the dealer has received a total number of cards that exceeds the total number of cards in all players' hands in the game.

U.S. Pat. No. 6,179,291 (Vancura) describes a casino table wagering game in which random events and their associated values are used (e.g., card rank). The teachings include a set of higher/lower hitting and standing rules in which a participant's successive event values are compared to determine the success or failure of a strategic decision. As a table game vs. a house dealer, the overall player's objective in a preferred embodiment is not to bust while achieving more hits than the dealer who plays by a fixed set of rules. Variations include a solitaire version, different payoff criteria and schedules, different definitions of what constitutes a successful hit, versions with a guaranteed-winner bonus round, and the introduction of jokers which may be helpful and/or harmful to the player's hand. When the dealer busts, the player automatically wins.

UNO® is a family card game by Mattel® that utilizes a custom deck of cards. The deck consists of 108 cards, of which there are 25 of each color (red, green, blue, and yellow), each color having two of each rank except zero. The ranks in each color are zero to nine, “Skip”, “Draw Two”, and “Reverse” (the last three being “action cards”). In addition, the deck contains four each of “Wild” and “Wild Draw Four” cards. The aim of the game is to be the first player to score 500 points, achieved (usually over several rounds of play) by a player discarding all of their cards and earning points corresponding to the value of the ranks of the remaining cards still held by the other players.

Each of the references discussed in this text art are incorporated herein in their entirety for all purposes.

It is always desirable to develop new and additional games for play on casino tables or machines, especially those that can be quickly learned, have a level of excitement and expectation to them, and have strategies that are easily understood.

### SUMMARY OF THE INVENTION

A wagering card game utilizing at least one deck of custom cards has at least one player competing against a dealer. The object of the game in determining a win versus a loss is to achieve a hand with the greatest number of cards possible without busting and to have a greater number of cards in the player's hand than the dealer has in the dealer's hand at the game's conclusion. Awards are based upon the degree of the number of cards in the player's hand exceeding the number of cards in the dealer's hand as a multiple of a player wager. The deck of custom cards comprises value cards and action cards. The value cards are sequentially numbered, and are marked by a special marking (either color, symbol, or pattern). The action cards do not have value but rather provide specific play directives. The game may be played as a live casino table card game with physical cards, a live electronic casino table card game, a video poker machine game, or with various virtual systems such as an Internet game, a stand alone video gaming apparatus, and a console multi-player format with seats for up to seven or more players with a video display of a dealer hand or even of a dealer.

### BRIEF DESCRIPTION OF THE FIGURES

FIG. 1 shows the layout of a casino table capable of executing the present invention.

FIG. 2 shows the cards of the custom deck of playing cards of the present invention.

FIG. 3 shows a close-up of the layout of the casino table depicting the play of one player position hand against one dealer position hand.

FIG. 4 shows a first game of the present technology.

FIG. 5 shows the first game of the present technology at a later stage.

FIG. 6 shows the first game of the present technology at a later stage.

FIG. 7 shows the first game of the present technology at a later stage.

FIG. 8 shows the first game of the present technology at a later stage.

FIG. 9 shows the first game of the present technology at a later stage.

FIG. 10 shows the first game of the present technology at a final resolution stage.

FIG. 11 shows a second game of the present technology.

FIG. 12 shows the second game of the present technology at a final resolution stage.

FIG. 13 shows a third game of the present technology at a first stage.

FIG. 14 shows the third game of the present technology at a later stage.

FIG. 14 shows the third game of the present technology at a later stage.

FIG. 15 shows the third game of the present technology at a later stage.

FIG. 16 shows the third game of the present technology at a later stage.

FIG. 17 shows the third game of the present technology at a final resolution stage.

FIG. 18 shows a physical casino gaming machine capable of executing the method of the present invention.

FIG. 19 shows another gaming network that may be used to implement some aspects of the present invention.

FIG. 20 shows yet another network device that may be configured for implementing some methods of the present invention.

### DETAILED DESCRIPTION OF THE INVENTION

A method for enabling play of a casino card game utilizes a predetermined amount of randomized decks of custom playing cards. Each custom deck of cards comprises a predetermined amount of sequentially numbered value cards and a predetermined amount of action cards, wherein the lowest card of the sequential value cards is alternately considered as a numbered card having the value of the highest card +1. Each value card is marked by a special marking (color, symbol, pattern, etc.) Each action card does not have value but rather indicates a play directive.

The player makes an ante bet in order to play the game and receives a first value card face up as an initial player hand. The dealer then receives one value card face up as an initial dealer hand. (If the first player card or the first dealer card is an action card, each action card(s) is/are discarded until a value card is dealt.) The player may either stand, thereby not having the opportunity to draw additional cards and continue the player's gameplay, or make a play wager in order to draw at least one additional card. If the player makes the play wager, one additional card is dealt face up to the player hand. If the additional card is an equal-value or higher-value card, or if the additional card matches the special marking of the first card, the player may choose to draw a second additional card. The player may choose to keep drawing further additional cards if any additional card is an equal-value or higher-value card, or if the additional card matches the special marking of the previous card. If at any time after the first additional card the player chooses not to draw any more additional cards, the player stands and the value of the player hand is the amount of cards in same hand. (If the player has stood on the initially dealt first card, the value of the player hand is “1”.) If at any time an additional card has a lower value than the preceding card without matching the marking of the preceding card, the player hand busts and at least the ante wager is lost.

An action card provides a play directive to at least: a) swap the last-dealt player card with the dealer up card; b) draw two mandatory cards; c) safely draw a card that cannot bust the player hand even if the said drawn card is lower than the previous card or does not match the previous card's marking; d) reverse the order of the cards in the player hand; or e) double the play wager. If at any time the player is dealt an action card, the action card is set aside and does not become an element of the player hand. Any particular rules of any dealt action card are mandatory and must be heeded by the player (unless the action card is an initially dealt card), and the player must still draw an additional card. If at any time a first action card is immediately followed by another action card, only the another action card must be heeded by the player, and the player must still draw an additional card.

If the player does not bust and after the player stands, the dealer hand is populated by additional cards until the dealer busts by drawing a card that is lower than the preceding card and that does not have the same marking as the preceding card. Upon the dealer bust, the dealer bust card is set aside, and the value of the dealer hand is the total of the amount of cards without the bust card (any action card dealt to the dealer is set aside and not considered in the play of the game).

The wager(s) is/are resolved by the difference between the value of the dealer hand and the value of the player hand. At the end of the game, if the value of the player hand is equal to the value of the dealer hand, the game may be either a draw or a win, according to predetermined rules. If the value of the player hand is less than the value of the dealer hand, the player loses his wager(s). If the value of the player hand is more than the value of the dealer hand, the wager(s) is/are resolved by multiplying the wager(s) by the difference between the two said values.

The method comprises hosting a wagering event during a card game on a physical casino table, wherein the deck of cards does not have to comprise a traditional deck of cards (2, 3, 4, 5, 6, 7, 8, 9, 10, J, Q, K, A), but rather preferably comprises a custom deck of cards.

The method may also comprise hosting a wagering event during a card game on an electronic gaming machine, electronic gaming table or blended physical playing cards with electronic card recognition/banker input and touchscreen. The electronic gaming machine may have a housing, player input control, video display including touchscreen sensitivity, processor, memory, and a value-in-value-out credit creation component selected from the group consisting of a) a ticket-in-ticket-out system having a ticket-reading scanner and ticket printer, and b) a currency validation system having a motor drive to advance currency past a scanner. The wagering event in an underlying card game is described below which may include: a player position committing credit through the player input controls on the bet wagering event; the processor resolving the wager by comparing correspondence of the identified card elements and their order against a paytable, then resolving the bet wager against a pay table identifying the correspondence, and crediting winning outcomes and decrementing credit in losing outcomes.

The player may enter a command through the player input controls to print a ticket from the ticket-in-ticket-out system to collect credit value stored in the memory of the electronic gaming machine. The dealing of playing cards may be automatically provided by execution of code from memory by the processor or the distribution of playing cards may be created by a player moving a finger in contact with the touchscreen, or by a player selecting random templates of patterns or outcomes stored in memory on the processor.

The present invention also provides an electronic gaming machine including a housing, player input control, video display including touchscreen sensitivity, processor, memory, and a value-in-value-out credit creation component selected from the group consisting of a) a ticket-in-ticket-out system having a ticket-reading scanner and ticket printer, and b) a currency validation system having a motor drive to advance currency past a scanner, wherein the processor is configured to execute software to execute a process on the said electronic gaming machine of: a player position committing credit through the player input controls on the wagering event; and upon the processor recognizing entry of a wager at a player position on the wagering event, allowing the player position to create a sequence of playing cards in respective hands according to the underlying method of executing the present wagering event.

### Computer-Based Implementations

Methods of the present invention may be implemented in computer hardware, software, or computer hardware and software. A most common form of computer implementation is a stand-alone, single player electronic gaming machine with electronic player controls and one or more video output screens.

In computer-based embodiments, the gaming device preferably includes at least one processor, such as a microprocessor, a microcontroller-based platform, a suitable integrated circuit or one or more application-specific integrated circuits (ASIC's) or Field Programmable Gated Arrays (FPGA's). The processor is in communication with or operable to access or to exchange signals with at least one data storage or memory device, and/or a player monitor or monitors. In one embodiment, the processor and the memory device reside within the cabinet of a gaming device. Multiple gaming devices are typically connected to a casino information network.

The memory device stores program code and instructions, executable by the processor, to control the gaming device. The memory device also stores other data such as image data, event data, player input data, random or pseudo-random number generators, pay-table data or information, House Ways distributions and applicable game rules that relate to the play of the gaming device. In one embodiment, the memory device includes random access memory (RAM): which can include non-volatile RAM (NVRAM): magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device.

In other embodiments, part or all of the program code and/or operating data described above can be downloaded to the memory device through a suitable network. In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. The gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “processor” or “computer” or “controller” or “game controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome. It is also possible for templates or weighted templates of sets of tiles or paylines as disclosed in U.S. Pat. Nos. 6,159,096 and 6,117,009 (Yoseloff, which are incorporated by reference in their entirety) which disclose a method of configuring a video output gaming device to randomly generate game outcomes. The method includes the steps of selecting a set of game symbols, assigning a probability of occurrence to each symbol, selecting a plurality of outcome templates, each template comprising X variables, selecting a probability of occurrence for each outcome template, assigning a subset of symbols from the set of game symbols to each template for filling the positions, defining payouts for selected outcomes, and configuring a video output gaming device, which randomly selects a template, randomly selects a symbol for each variable in the template from the subset of game symbols assigned to the selected template, randomly fills at least a portion of the positions in the template and displays the outcome on a video output display. A video output gaming device programmed to randomly select a template, randomly select symbols to define the variables and randomly display the selected symbols is also disclosed.

In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display that displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

### Chipless Gaming Table Implementation

One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like. In order to prevent a bet pattern exceeding the number of possible hands in a “live” shoe, a card count will be tracked and the remaining cards will be continually divided by six (the maximum number of cards for a hand). With regard to software f), it is understood in the practice of the present technology that this is not complex software that reads individual player hand cards and determines advantageous card distributions for a first time by extensive calculations. Rather, the entire range of possibilities of hands (e.g., all possible five card sets dealt to players in poker-style games) is known in poker style games.

A preferable card handling device for administering a video reel-type-style game is a hand-forming shuffler with integrated card recognition technology, from which playing cards are supplied, with a least a rank/count (and preferable also suit) of individual packs of cards are known before the cards are removed and delivered to player positions and/or the banker position. The card delivery system is in communication with the controller by wired or wireless communication methods. Communication between the various system components is not limited to electronic or electrical signals, but may include optical signals, audio signals, magnetic transmission or the like.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

Many different types of games, including mechanical slot games, video slot games, video poker, video blackjack, video pachinko and lottery, may be provided with gaining machines of this invention. In particular, the gaming machine may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine may be stored as game software on a mass storage device in the gaming machine or may be generated on a remote gaming device but then displayed on the gaming machine. The gaming machine may executed game software, such as but not limited to video streaming software that allows the game to be displayed on the gaming machine. When an instance is stored on the gaming machine, it may be loaded from the mass storage device into a RAM for execution. In some cases, after a selection of an instance, the game software that allows the selected instance to be generated may be downloaded from a remote gaming device, such as another gaming machine.

The gaming machine includes a top box, which sits on top of the main cabinet. The top box houses a number of devices, which may be used to add features to a game being played on the gaming machine, including speakers, a ticket printer which prints bar-coded tickets, a key pad for entering player tracking information, a florescent display for displaying player tracking information, a card reader for entering a magnetic striped card containing player tracking information, and a video display screen. The ticket printer may be used to print tickets for a cashless ticketing system. Further, the top box may house different or additional devices. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet of the machine.

Understand that said gaming machine is but one example from a wide range of gaining machine designs on which the present invention may be implemented. For example, not all suitable gaming machines have top boxes or player tracking features. Further, some gaming machines have only a single game display mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art understand that the present invention, as described below, can be deployed on most any gaming machine now available or hereafter developed.

Some preferred gaming machines are implemented with special features and/or additional circuitry that differentiates them from general-purpose computers (e.g., desktop PCs and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaining machine.

A second important difference between gaming machines and common PC-based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically add, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog tinier subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously, presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When pc is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

A first preferred game method of the present invention provides a wagering card table game between a dealer and a player. The table game may comprise a physical table with physical cards, or may comprise an electronic table enabled to provide play of said wagering card game. The object of the game is for the player to have an amount of cards in his/her final hand of cards that is at least equal to, but preferably more than, the amount of cards in the final dealer hand. Awards are provided according to the difference in the amount of cards between the player hand and the dealer hand.

The said first preferred game method utilizes a custom deck of cards comprising 46 cards. There are 40 value cards that are numbered 1 through 10 inclusive and wherein there are four of each unique number. The numbered “1” card is labeled “1/11” so that it is considered as either a high card (11) in order to safely be higher than the previous card, but also can be then considered as a low card (1) in order to keep drawing cards to the player or dealer hand. Each of the four unique numbers is marked by a unique color (yellow, blue, red, green, respectively). There are also six action cards, wherein there are two each of “Draw 2”, “Swap” and “Safe”. A “Draw 2” action card provides a play directive to draw two mandatory cards. A “Swap” action card provides a play directive to choose (or not choose) to swap the last-dealt player card with the dealer up card. A “Safe” card allows the player to safely draw a card that cannot bust the player hand even if the said drawn card is lower than the previous card or does not match the previous card's color.

The game method begins with the player making an ante bet in order to play the game. Upon making the ante wager, the player is dealt one card face up. (If the said one card is an action card, the card is set aside and is not part of the gameplay. A next card is then dealt, and so on, until a value card is dealt.) The dealer is then dealt one value card face up, likewise setting aside any value cards that may be dealt before the value card.

Next, the player may either stand, thereby not having the opportunity to draw additional cards and continue the player's gameplay, or make a play wager in order to draw at least one additional card. The play wager may be less than or more than the ante wager, but preferably equal to the ante wager. If the player makes the play wager, one additional card is dealt face up to the player hand. If the additional card is an equal-value or higher-value card, or if the additional card matches the color of the first card, the player may choose to draw a second additional card. The player may choose to keep drawing further additional cards if any additional card is an equal-value or higher-value card, or if the additional card matches the color of the previous card. If at any time after the first additional card is dealt and the player chooses not to draw any more additional cards, the player stands and the value of the player hand is the amount of cards in said hand. (If the player has stood on the initially dealt first card, the value of the player hand is “1”.) If at any time an additional card has a lower value than the preceding card without matching the color of the preceding card, the player hand busts and both the ante wager and the play wager are lost. If at any time the player is dealt an action card, the action card is set aside and does not become an element of the player hand. Again, the rules pertaining to any dealt action card are mandatory and must be heeded by the player (unless the action card is an initially dealt card), and the player must still draw an additional card. If at any time a first action card is immediately followed by another action card, only the another action card must be heeded by the player, and the player must still draw an additional card.

If the player does not bust and after the player stands, the dealer hand is populated by additional cards until the dealer busts by drawing a card that is lower than the preceding card and does not have the same marking as the preceding card. Upon the dealer bust, the dealer bust card is set aside, and the value of the dealer hand is the total of the amount of cards without the bust card (any action card dealt to the dealer is set aside and not considered in the play of the game).

The wager(s) (ante wager only, or ante wager+play wager, or play wager only, depending on predetermined rules) is/are resolved by the difference between the value of the dealer hand and the value of the player hand. At the end of the game, if the value of the player hand is equal to the value of the dealer hand, the game may be either a draw or a win, according to predetermined rules. If the value of the player hand is less than the value of the dealer hand, the player loses his wager(s). If the value of the player hand is more than the value of the dealer hand, the wager(s) is/are resolved by multiplying the wager(s) by the difference between the two said values.

A second preferred game method of the present invention provides an electronic wagering card game on a video card game machine between a virtual dealer and a player. The object of the game is for the player to have an amount of cards in his/her final hand of cards that is at least equal to, but preferably more than, the amount of cards in the final dealer hand. Awards are provided according to the difference in the amount of cards between the player hand and the dealer hand.

The video card game machine comprises a housing; at least one display device; at least one processor; at least one physical input device configured to detect a physical item associated with a monetary amount that establishes a credit balance; at least an electronic input device; and at least one memory device which stores a plurality of instructions which, when executed by the at least one processor, cause the at least one processor to operate with the at least one display device and the at least one electronic input device to perform the said second game method.

The said second preferred game method utilizes a custom deck of virtual cards comprising 46 cards. There are 40 value cards that are numbered 1 through 10 inclusive and wherein there are four of each unique number. The numbered “1” card is labeled “1/11” so that it is considered as either a high card (11) in order to safely be higher than the previous card, but also can be then considered as a low card (1) in order to keep drawing cards to the player or dealer hand. Each of the four unique numbers is marked by a unique color (yellow, blue, red, green, respectively). There are also six action cards, wherein there are two each of “Draw 2”, “Swap” and “Safe”. A “Draw 2” action card provides a play directive to draw two mandatory cards. A “Swap” action card provides a play directive to choose (or not choose) to swap the last-dealt player card with the dealer up card. A “Safe” card allows the player to safely draw a card that cannot bust the player hand even if the said drawn card is lower than the previous card.

The said second game machine method begins with the player engaging at least one physical input device configured to detect a physical item associated with a monetary amount that establishes a credit balance. By utilizing the electronic input device, the player makes an ante wager in order to play the game, and is dealt one card face up. (If the said one card is an action card, the card is set aside and is not part of the gameplay. A next card is then dealt, and so on, until a value card is dealt.) The dealer is then dealt one value card face up, likewise setting aside any action cards that may be dealt before the value card.

Next, by utilizing the electronic input device, the player may either stand, thereby not having the opportunity to draw additional cards and continue the game, or make a play wager in order to draw at least one additional card. The play wager may be less than, equal to, or more than the ante bet. If the player makes the play wager, one additional card is dealt face up to the player hand. If the additional card is an equal-value or higher-value card, or if the additional card matches the color of the first card, the player may choose to draw a second additional card. The player may choose to keep drawing further additional cards if any additional card is an equal-value or higher-value card, or if the additional card matches the color of the previous card. If at any time after the first additional card is dealt and the player chooses not to draw any more additional cards, the player stands and the value of the player hand is the amount of cards in said hand. (If the player has stood on the initially dealt first card, the value of the player hand is “1”.) If at any time an additional card has a lower value than the preceding card without matching the color of the preceding card, the player hand busts and both the ante wager and the play wager are lost. If at any time the player is dealt an action card, the action card is set aside and does not become an element of the player hand. Again, the rules pertaining to any dealt action card are mandatory and must be heeded by the player (unless the action card is an initially dealt card), and the player must still draw an additional card. If at any time a first action card is immediately followed by another action card, only the another action card must be heeded by the player, and the player must still draw an additional card.

If the player does not bust and after the player stands, the dealer hand is populated by additional cards until the dealer busts by drawing a card that is lower than the preceding card and does not have the same marking as the preceding card. Upon the dealer bust, the dealer bust card is set aside, and the value of the dealer hand is the total of the amount of cards without the bust card (any action card dealt to the dealer is set aside and not considered in the play of the game).

The wager(s) (ante wager only, or ante wager+play wager, or play wager only, depending on predetermined rules) is/are resolved by the difference between the value of the dealer hand and the value of the player hand. At the end of the game, if the value of the player hand is equal to the value of the dealer hand, the game may be either a draw or a win, according to predetermined rules. If the value of the player hand is less than the value of the dealer hand, the player loses his wager(s). If the value of the player hand is more than the value of the dealer hand, the wager(s) is/are resolved by multiplying the wager(s) by the difference between the two said values. Any winning wager may initiate a payout associated with the credit balance after an actuation of a cashout button is received.

Reference to the Figures will assist in further understanding of the practice of the present invention.

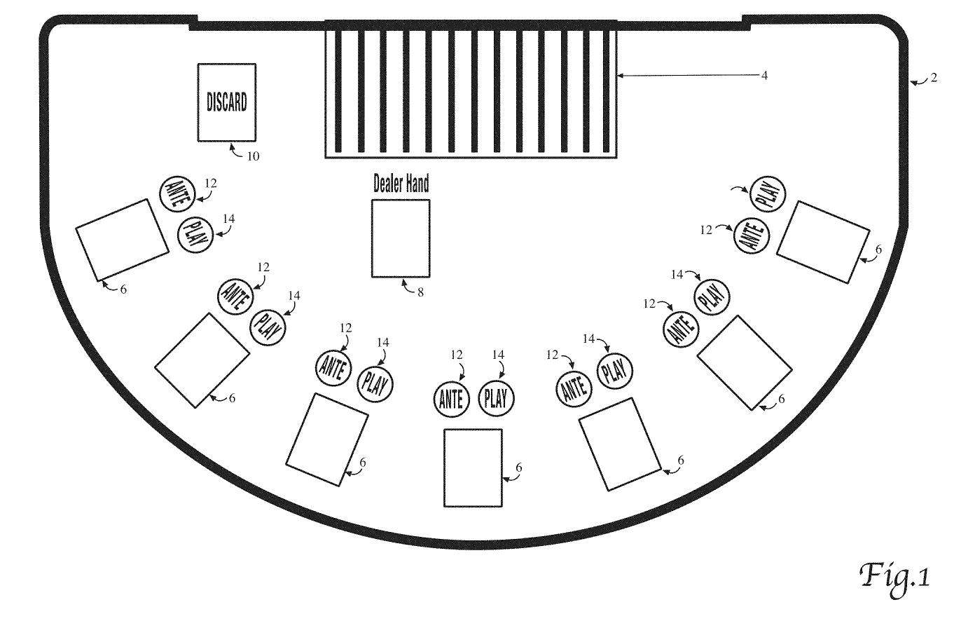

FIG. 1 illustrates a preferred layout for the present invention for a casino gaming table 2 that provides seating for up to 7 players. A chip compartment 4 is depicted. Each player area comprises a first card location 6, a circle for placing an ante bet 12, and a circle for placing a play bet 14. A dealer's first card location 8 is depicted, as well as a discard card location 10.

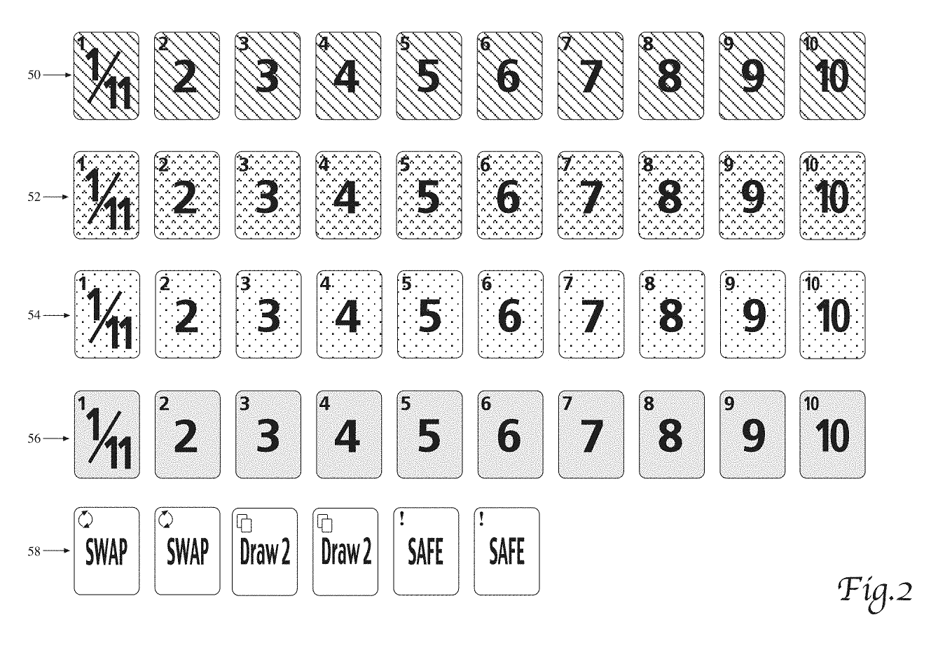

FIG. 2 illustrates a preferred deck of cards for the present invention, comprising ten value cards (1-10) with a diagonal pattern 50, ten value cards (1-10) with a chevron pattern 52, ten value cards (1-10) with a dot pattern 54, and ten value cards (1-10) with a solid light grey pattern 56. It is noted that each “1” card is also considered to be an “11” card. Also shown are two each of three action cards 58: Swap, Draw 2, and Safe.

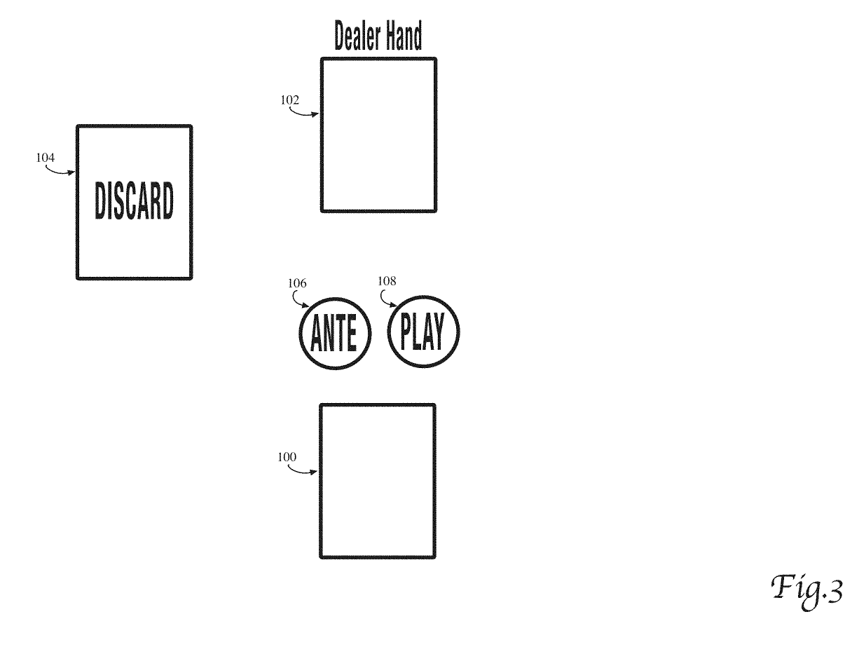

FIG. 3 illustrates a close-up section of the casino gaming table 2 of FIG. 1, depicting one player hand comprising a first card location 100, a dealer's first card location 102, a discard card location 104, an ante bet circle 106 and a play bet circle 108.

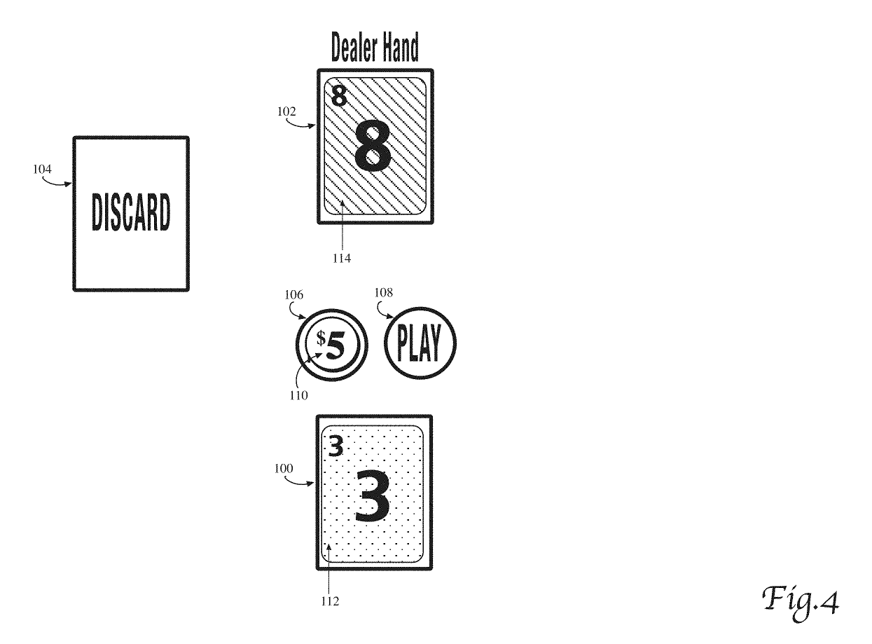

FIG. 4 shows the beginning of a first game of the present invention and refers to the elements in FIG. 3 with the player placing a $5 chip 110 for the ante bet. The player is dealt a “3” card 112 and the dealer is dealt an “8” card 114.

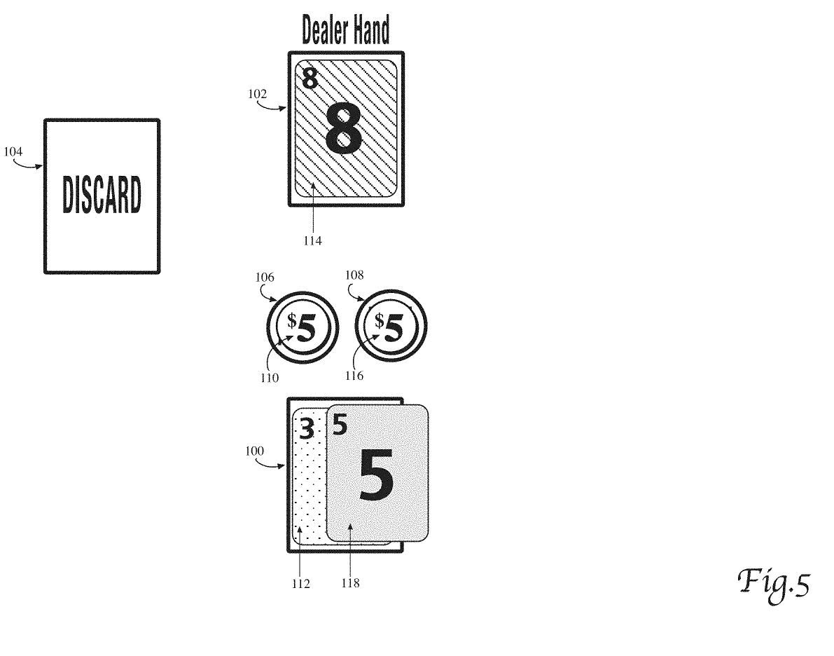

FIG. 5 shows the continuation of the first game of the present invention and refers to the elements in FIG. 4 with the player placing a $5 chip 116 for the play bet, allowing the player to draw additional card(s). (Since each additional card must be equal to or higher than the previous card, the player has decided that he has a better chance to obtain a final hand with more cards than the dealer.) The player draws a “5” card 118. Since the additional card is higher than the previous card, the player may choose to continue drawing or to stand.

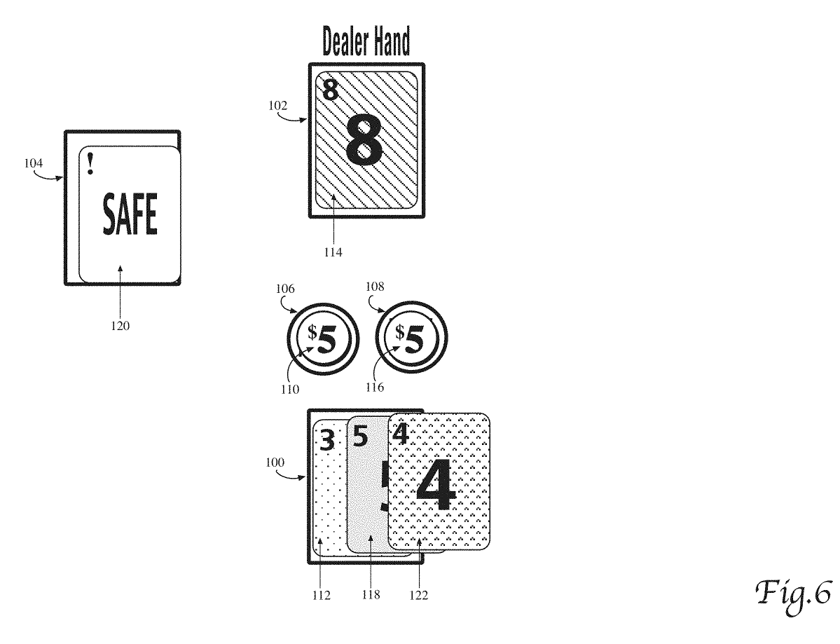

FIG. 6 shows the further continuation of the first game of the present invention and refers to the elements in FIG. 5 wherein the player draws a “SAFE” card 120 that is automatically placed on the discard card location 104. The player then draws a “4” card 122 (the player must always draw a card after an action card). Even though the “4” is less than the “5” card, it is a SAFE card, so the play may continue. Since the additional card is SAFE, the player may choose to continue drawing or to stand.

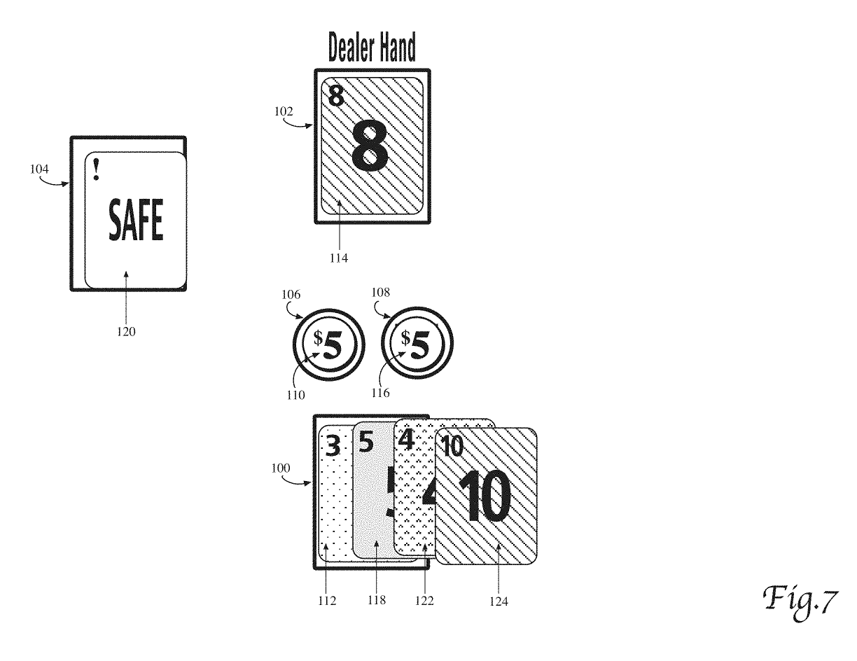

FIG. 7 shows the further continuation of the first game of the present invention and refers to the elements in FIG. 6 wherein the player has chosen to continue the game, and draws a “10” card 124. The player then chooses to stand. The value of the final player hand is 4 since there are four cards in the player hand.

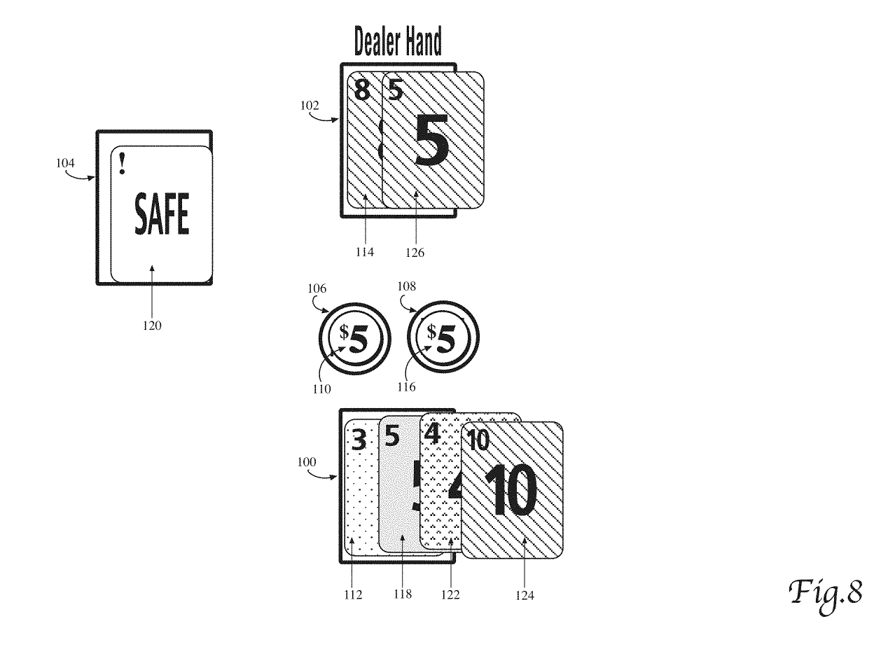

FIG. 8 shows the further continuation of the first game of the present invention and refers to the elements in FIG. 7 wherein the dealer draws a “5” card 126. Even though the “5” is lower than the “8”, its diagonal pattern matches the diagonal pattern of the previous card, so the dealer hand remains in play. (The dealer must continue drawing until a bust card.)

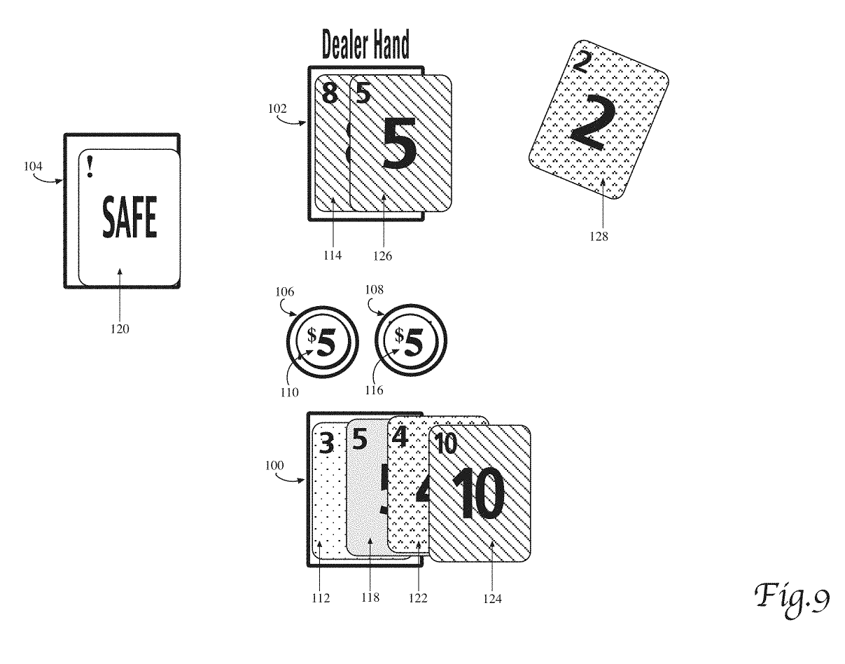

FIG. 9 shows the further continuation of the first game of the present invention and refers to the elements in FIG. 8 wherein the dealer draws a “2” card 128. Since the “2” card is lower than the previous card, nor does it match the pattern of the previous card, the dealer busts. The “2” card is set off to the side and not considered in the value of the hand. The value of the final dealer hand is 2, since there are two cards in the dealer hand.

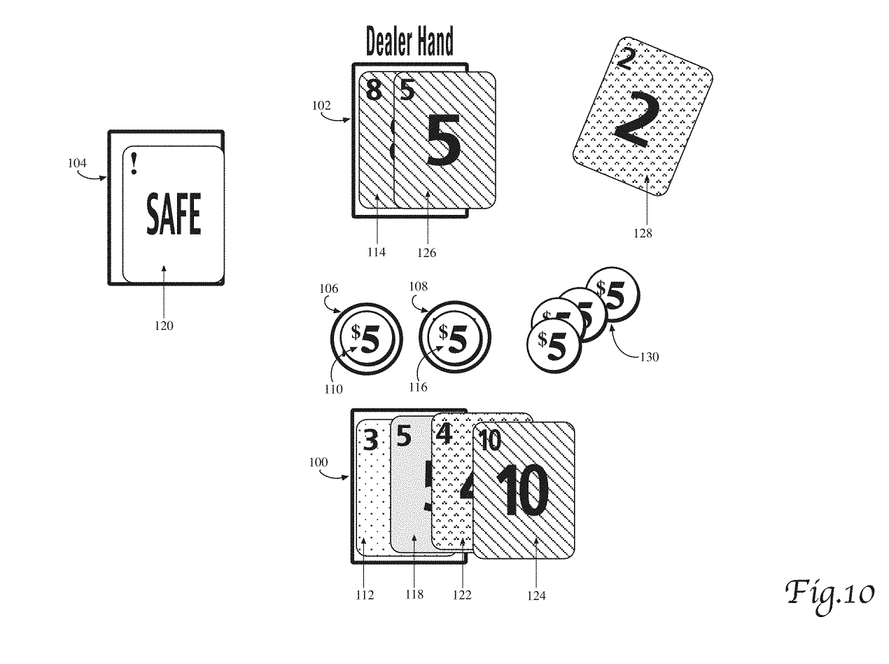

FIG. 10 shows the final result of the first game of the present invention and refers to the elements in FIG. 9 wherein the difference between the value of the player hand and the dealer hand is 2 (4−2=2). The player wins 2× the total bet of $10, and is paid $20 (four $5 chips 130).

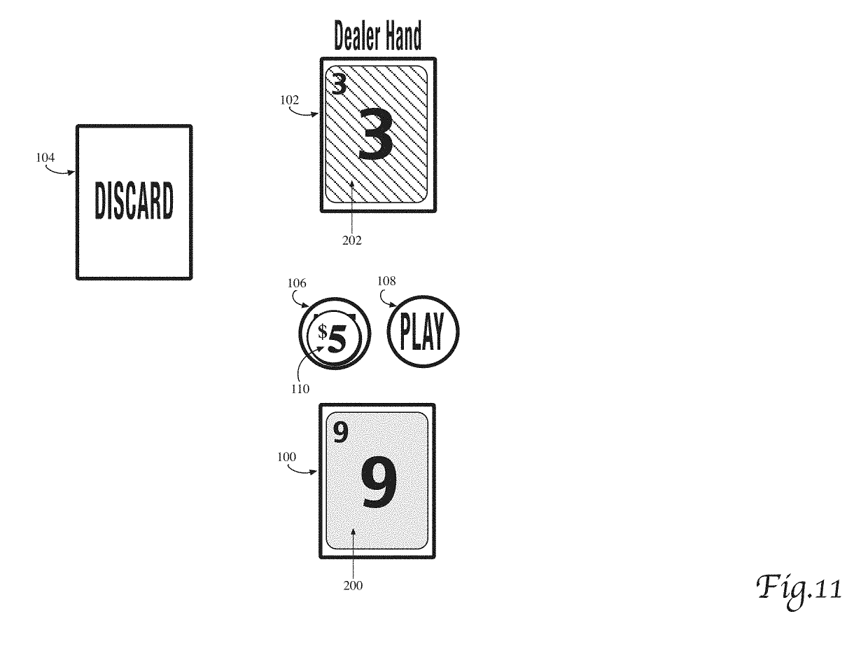

FIG. 11 shows the beginning of a second game of the present invention and refers to the elements in FIG. 4 with the player placing a $5 chip 110 for the ante bet. The player is dealt a “9” card 200 and the dealer is dealt a “3” card 202. The player chooses to stand, not wanting to risk any more money with making a play bet.

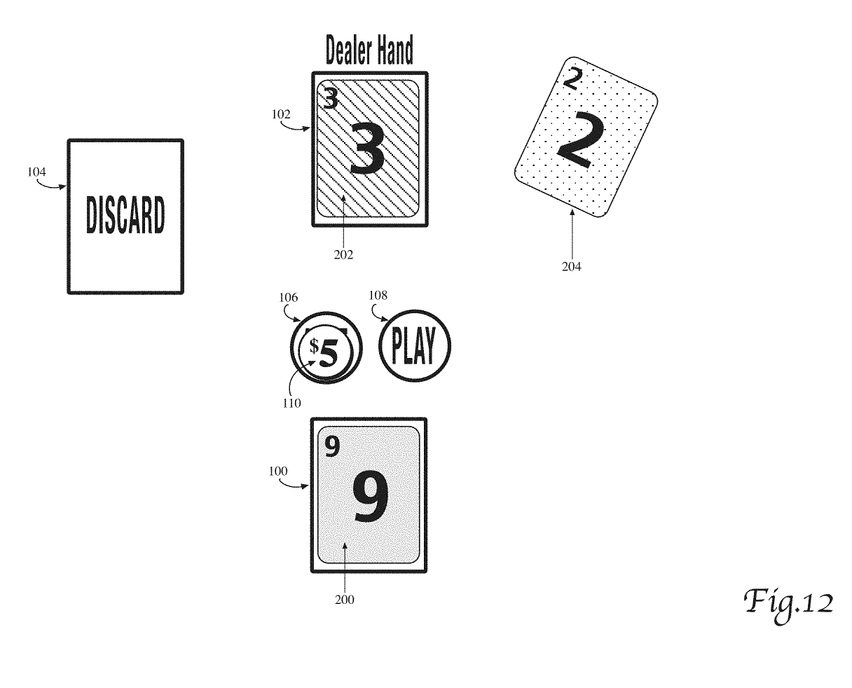

FIG. 12 shows the final result of the second game of the present invention and refers to the elements in FIG. 11 with the dealer drawing a “2” card 204 that is lower than the previous card and that does not match the pattern of the previous card. The bust “2” card is set aside, and the player hand and the dealer hand each have a value of 1 (one card in each final hand). The game is a push, and the player keeps the ante bet.

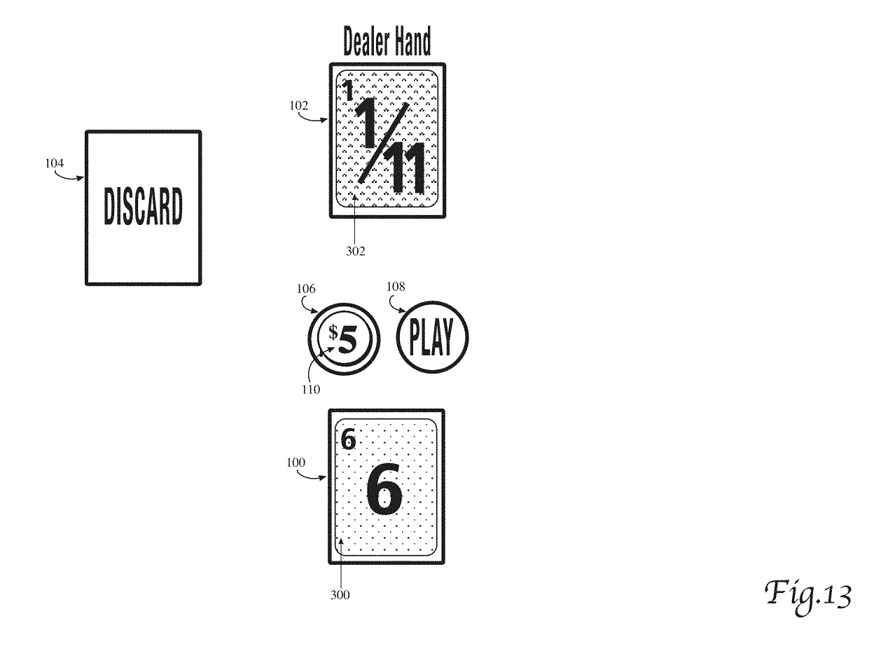

FIG. 13 shows the beginning of a third game of the present invention and refers to the elements in FIG. 4 with the player placing a $5 chip 110 for the ante bet. The player is dealt a “6” card 300 and the dealer is dealt a “1/11” card 302.

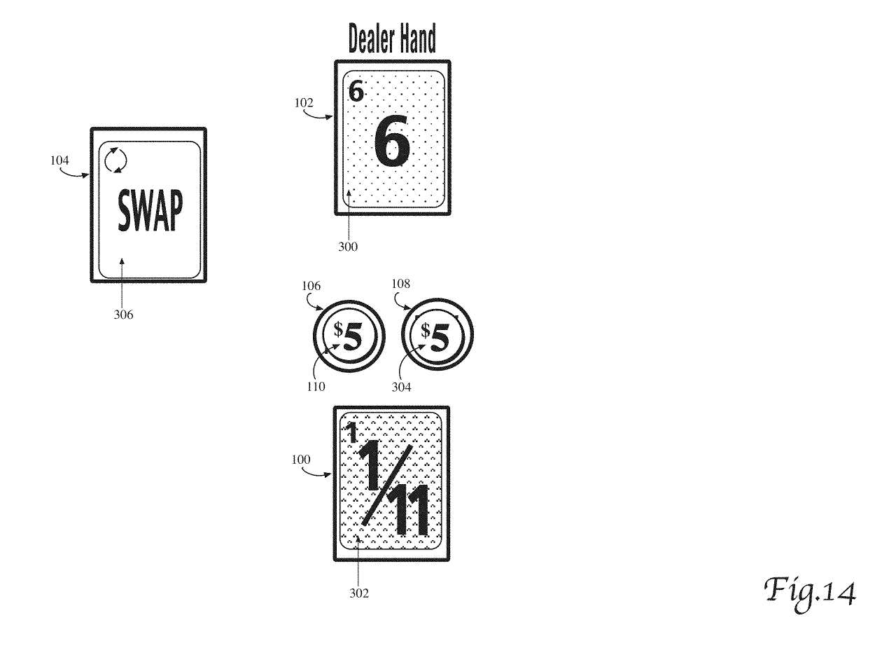

FIG. 14 shows the continuation of the third game of the present invention and refers to the elements in FIG. 13 where the player has chosen to continue play by placing a $5 play bet 304. (Since the dealer has a “1/11” card, the dealer cannot bust on one additional card, giving his hand a value of at least 2. If the player stands, the player hand has a value of 1, so the player will automatically lose his ante bet anyway. Of course the player may stand, and automatically lose the ante bet, if he so chooses, without risking the additional play bet.) The player draws a “SWAP” card 306 that allows the player the choice to swap the top card in his hand with the dealer up card. Here the player does choose to SWAP, and now the player hand has the “1/11” card 302, and the dealer hand has the “6” card 300.

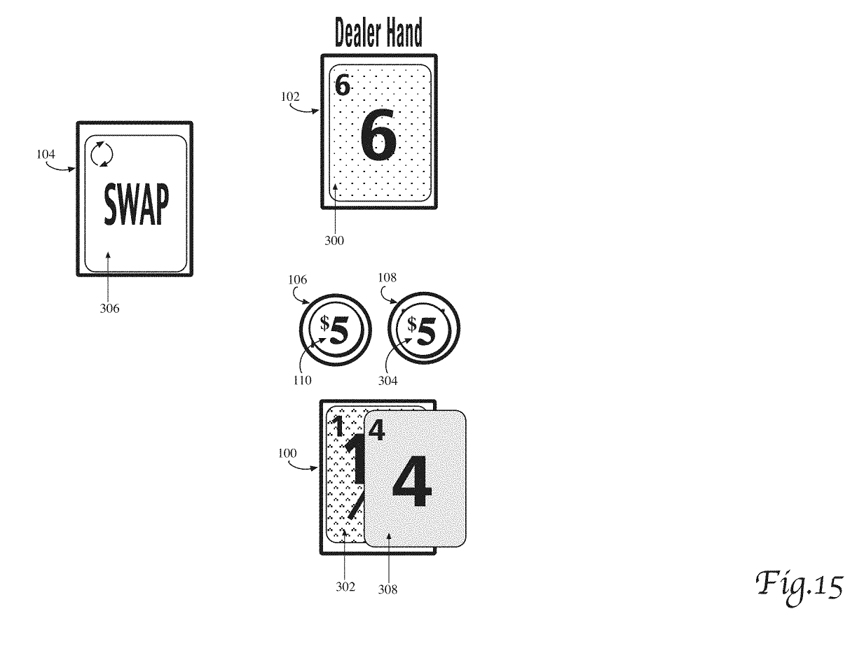

FIG. 15 shows the continuation of the third game of the present invention and refers to the elements in FIG. 14 where the player draws the one mandatory card after an action card, in this case a “4” card 308.

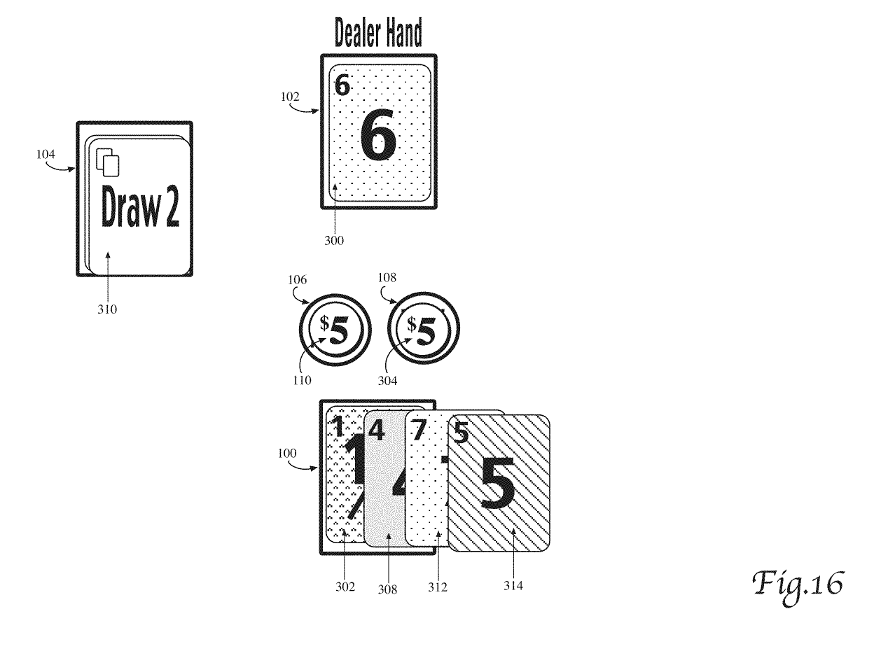

FIG. 16 shows the continuation of the third game of the present invention and refers to the elements in FIG. 15 where the player continues play by drawing a “DRAW 2” card 310. Now the player MUST draw two cards, in this case firstly a “7” card 312 and secondly a “5” card. Unfortunately, the “5” care is not higher than the previous card, nor does it match the pattern of the previous card.

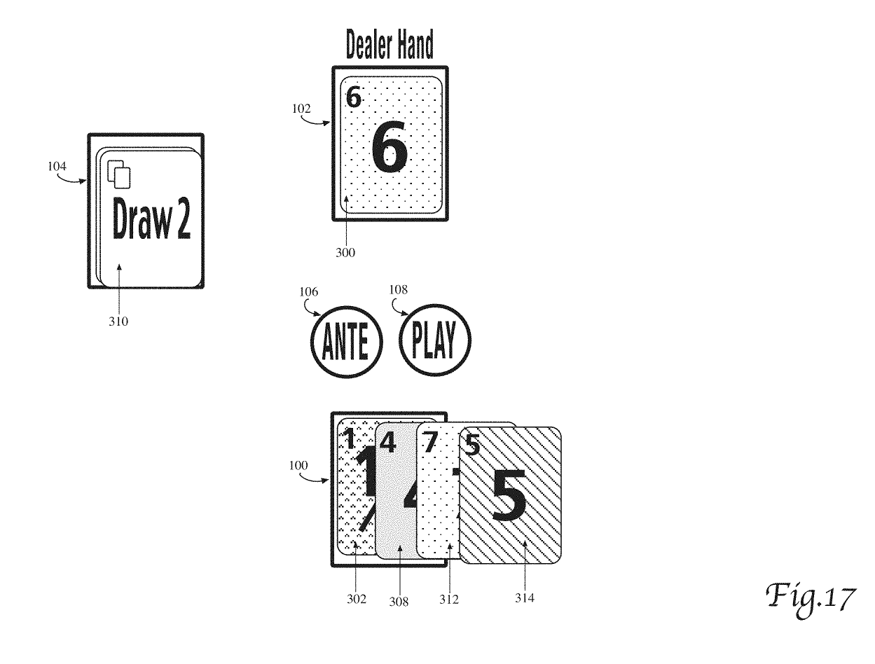

FIG. 17 shows the final result of the third game of the present invention and refers to the elements in FIG. 16 wherein the player hand busts, and both the ante bet and the play bet are lost.

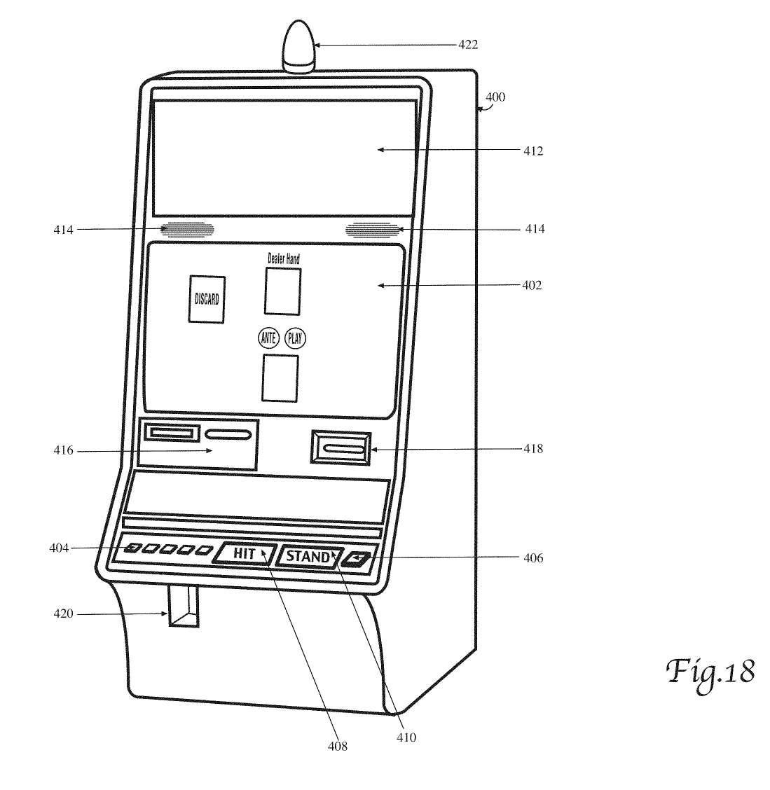

FIG. 18 illustrates a gaming machine that includes at least a cabinet 400 and monitor screen 402 capable of displaying a video gambling game. The gaming machine comprises at least physical buttons 404 that enable a player select a specific wager amount, a physical “HIT” button 408 and a physical “STAND” button 410 that enable a player to either continue or stop additional play, and a physical PLAY GAME button 406. An additional video monitor screen 412 may be provided, upon which individual game symbols or instructions may be displayed. The gaming machine or apparatus preferably also includes speakers 414, and a value input/output device 416 that allows a player to insert value for game play or extract value of said game play. A separate device 418 is provided that preferably enables a player card or ticket to be inserted for the purpose of keeping track of player information, providing information of benefits or events, and the like. In rarer or older examples, a coin output device 420 may be provided. An electronic signaling device 422 may be apportioned on the top of the gaming machine to signal information of wins or needs to the appropriate people or employees.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches, the video display screen or using some other device which enables a player to input information into the gaming machine. In some embodiments, the player may be able to access various game services such as concierge services and entertainment content services using the video display screen and one more input devices.

During certain game events, the gaming machine may display visual and auditory effects that can be perceived by the player. These effects add to the excitement of a game, which makes a player more likely to continue playing. Auditory effects include various sounds that are projected by the speakers. Visual effects include flashing lights, strobing lights or other patterns displayed from lights on the gaming machine or from lights within the separate mechanical (or electronic) separately, individually wagerable gaming system. After the player has completed a game, the player may receive game tokens from the coin tray or the ticket from the printer, which may be used for further games or to redeem a prize. Further, the player may receive a ticket for food, merchandise, or games from the printer.

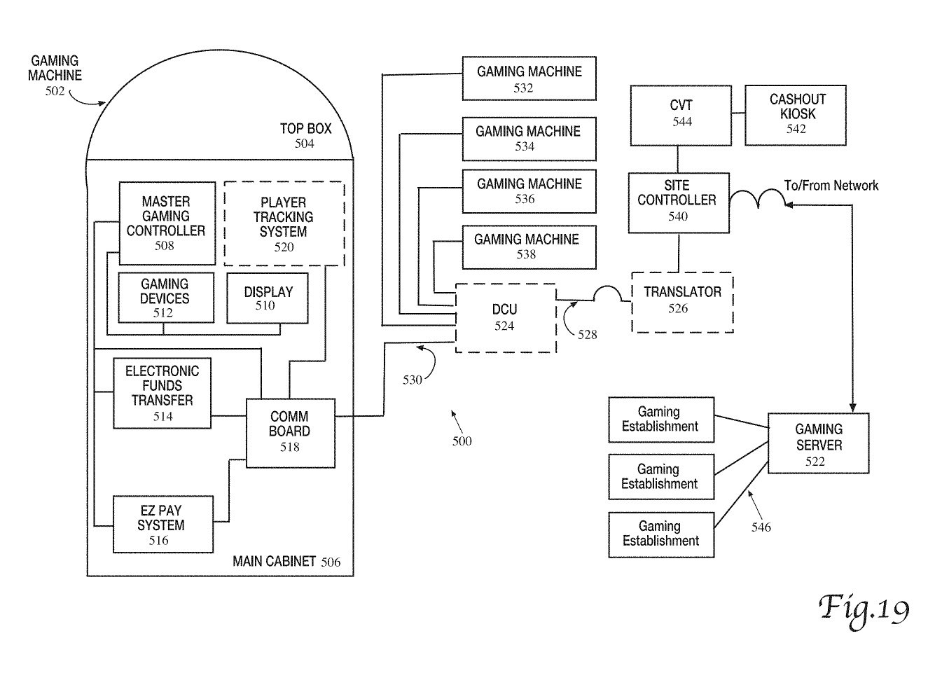

Another gaming network that may be used to implement some aspects of the invention is depicted in FIG. 19. Gaming establishment 500 could be any sort of gaming establishment, such as a casino, a card room, an airport, a store, etc. In this example, gaming network 546 includes more than one gaming establishment, all of which are networked to game server 522. Here, gaming machine 502, and the other gaming machines 532, 534, 536 and 538, include a main cabinet 506 and a top box 504. The main cabinet 506 houses the main gaming elements and can also house peripheral systems, such as those that utilize dedicated gaming networks. The top box 504 may also be used to house these peripheral systems.

The master gaming controller 508 controls the game play on the gaming machine 502 according to instructions and/or game data from game server 522 or stored within gaming machine 502 and receives or sends data to various input/output devices 512 on the gaming machine 502. In one embodiment, master gaming controller 508 includes processor(s) and other apparatus of the gaming machines described above. The master gaming controller 508 may also communicate with a display 510.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 508 may also communicate with EFT system 514, EZPay™ system, and player tracking system 520. The systems of the gaming machine 502 communicate the data onto the network 522 via a communication board 518 and transmittal line 530.

It will be appreciated by those of skill in the art that embodiments of the present invention could be implemented on a network with more or fewer elements than are depicted in FIG. 19. For example, player tracking system 520 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 524 and translator 526 are not required for all gaming establishments 500. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Furthermore, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 540 provides this function for gaming establishment 546. Site controller 540 is connected to a central system and/or other gaming establishments via one or more networks, which may be public or private networks. Among other things, site controller 540 communicates with game server 522 to obtain game data, such as ball drop data, bingo card data, etc.

In FIG. 19, gaming machines 532, 534, 536 and 538 are connected to a dedicated gaming network 522. In general, the DCU 524 functions as an intermediary between the different gaming machines on the network 522 and the site controller 540. In general, the DCU 524 receives data transmitted from the gaming machines and sends the data to the site controller 540 over a transmission path 528. In some instances, when the hardware interface used by the gaming machine is not compatible with site controller 540, a translator 526 may be used to convert serial data from the DCU 524 to a format accepted by site controller 540. The translator may provide this conversion service to a plurality of DCUs.

Further, in some dedicated gaming networks, the DCU 524 can receive data transmitted from site controller 540 for communication to the gaming machines on the gaming network. The received data may be, for example, communicated synchronously to the gaming machines on the gaming network.

Here, CVT 544 provides cashless and cashout gaming services to the gaming machines in gaming establishment 546. Broadly speaking, CVT 544 authorizes and validates cashless gaming machine instruments (also referred to herein as “tickets” or “vouchers”), including but not limited to tickets for causing a gaming machine to display a game result and cash-out tickets. Moreover, CVT 544 authorizes the exchange of a cashout ticket for cash. These processes will be described in detail below. In one example, when a player attempts to redeem a cash-out ticket for cash at cashout kiosk 1044, cash out kiosk 542 reads validation data from the cashout ticket and transmits the validation data to CVT 544 for validation. The tickets may be printed by gaming machines, by cashout kiosk 542, by a stand-alone printer, by CVT 544, etc. Some gaming establishments will not have a cashout kiosk 542. Instead, a cashout ticket could be redeemed for cash by a cashier (e.g. of a convenience store), by a gaming machine or by a specially configured CVT.

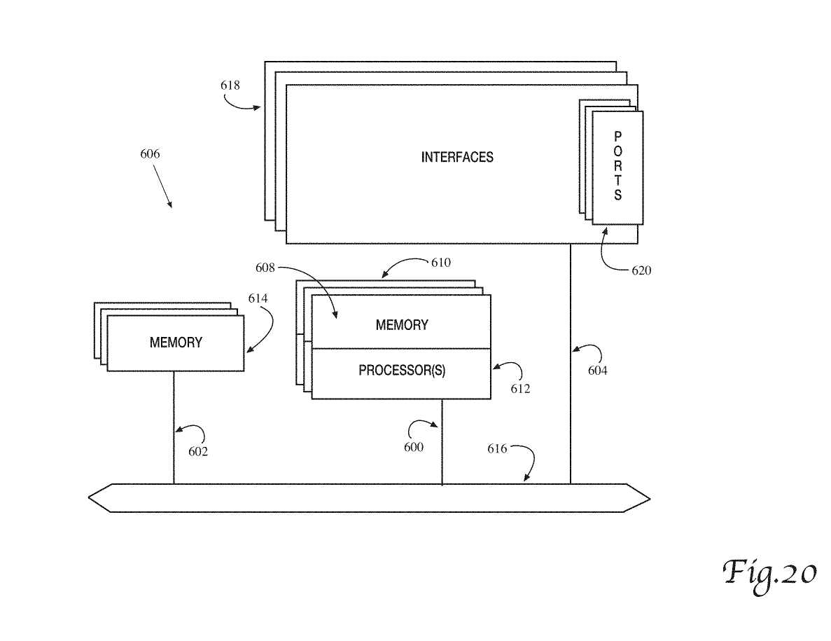

FIG. 20 illustrates an example of a network device that may be configured for implementing some methods of the present invention. Network device 606 includes a master central processing unit (CPU) 610, interfaces 618, and a bus 616 (e.g., a PCI bus). Generally, interfaces 618 include ports 620 appropriate for communication with the appropriate media. In some embodiments, one or more of interfaces 618 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 618 control such communications-intensive tasks as encryption, decryption, compression, decompression, packetization, media control and management. By providing separate processors for the communications-intensive tasks, interfaces 618 allow the master microprocessor 610 efficiently to perform other functions such as routing computations, network diagnostics, security functions, etc.

The interfaces 618 are typically provided as interface cards (sometimes referred to as “linecards”). Generally, interfaces 618 control the sending and receiving of data packets over the network and sometimes support other peripherals used with the network device 606. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 610 may be responsible for implementing specific functions associated with the functions of a desired network device. According to some embodiments, CPU 610 accomplishes all these functions under the control of software including an operating system and any appropriate applications software.

CPU 610 may include one or more processors 612 such as a processor from the Motorola family of microprocessors or the MIPS family of microprocessors. In an alternative embodiment, processor 612 is specially designed hardware for controlling the operations of network device 606. In a specific embodiment, a memory 608 (such as non-volatile RAM and/or ROM) also forms part of CPU 610. However, there are many different ways in which memory could be coupled to the system. Memory block 608 may be used for a variety of purposes such as, for example, caching and/or storing data, programming instructions, etc.

Regardless of network device's configuration, it may employ one or more memories or memory modules (such as, for example, memory block 614) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 20 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 20) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

Although the appearance of the devices and schematics of FIGS. 18, 19 and 20 are similar to those known in the art, they are not Prior Art in that they include the software and images essential to the execution of the present invention. And although specific examples and specific pay schemes have been provided in this discussion, these specifics are intended to be only support for the generic concepts of the invention and are not intended to be absolute limits in the scope of the technology discussed.

What is claimed:

1. A method for enabling play of a casino table card game, using a predetermined number of randomized decks of custom playing cards wherein each deck has fewer than 52 cards and wherein:
a) each custom deck of cards comprises a predetermined number of sequentially numbered value cards and a predetermined number of action cards fewer in number than the predetermined number of sequentially numbered value cards and action cards having game play directives thereon;
b) a lowest card of the sequentially numbered value cards are numbered cards having an alternate value of a highest card value +1;
c) each value card additionally has a casino table card game special marking;
d) each action card has no game value but rather indicates a casino table card game play directive;
the method performed when a player position makes an ante bet to play the casino table card game and receives one random card from the custom deck of cards face up as an initial player position hand, and a dealer position then receives one random card from the custom deck of cards face up as an initial dealer position hand, wherein:
e) if the first player position card is an action card, the action card is discarded and additional random cards are dealt to the player hand position until a value card is dealt to the player position hand;
f) the player position may I) stand, thereby not having an opportunity to draw additional cards and continue the casino table card game, or II) make a play wager in order to draw at least one additional random card from the custom deck of cards;
g) if the player position has made the play wager, one additional card is dealt to the player position hand from the custom deck of cards;
h) if the additional card is an equal-value or higher-value card compared to the first value card in the player position hand, or if the additional card matches the special marking of the first value card in the player position hand, the player position may choose or decline to draw a second additional card;
i) the player position may choose to keep drawing further additional cards if any additional card is a higher-valued card than the preceding value card in the player position hand, or if the special marking of the additional card matches the special marking of the said preceding value card in the player position hand;
j) if at any time after the first additional card the player position chooses not to draw any more additional cards, the player position stands and the value of the player hand is determined as the total number of cards in said hand;
k) if at any time an additional card has a lower value than the preceding card without matching the marking of the said preceding card, the player position hand busts and both the ante wager and the play wager are forfeit;
l) if at any time the player position is dealt an action card, the action card is set aside and does not become an element of the player position hand;
m) any directives of any dealt action card are mandatory and must be acted upon by the player, and the player position must still draw an additional card;
n) if at any time a first action card is immediately followed by another action card from the custom deck, only the another action card must be acted upon by the player, and the player must still draw an additional card;
o) if the player position does not bust and after the player stands, the dealer position hand is populated by additional cards until the dealer position hand busts by drawing a card from the custom deck that is lower than the preceding card and does not have the same marking as the said preceding card to the dealer position hand;
p) if any action card is dealt to the dealer position hand, the said action card is discarded and its game play directive is not acted upon by the dealer hand position;
q) upon the dealer position hand busting, the dealer position hand bust card is set aside, and the value of the dealer hand is the total of the number of cards in said hand without counting the bust card; and
r) at least the ante wager is resolved by a difference between the value of the dealer hand and the value of the player hand.

2. The method of claim 1 wherein each sequentially numbered value card is marked by a color, a symbol or a pattern.

3. The method of claim 1 wherein an action card at least defines a play directive to: a) swap the last-dealt player card with the dealer up card; b) draw two mandatory cards; c) safely draw a card that cannot bust the player hand even if the said drawn card is lower than the previous card; d) reverse the order of the cards in the player hand; or e) double the play wager.

4. The method of claim 1 wherein the custom deck of playing cards comprises 46 cards.

5. The method of claim 4 wherein there are 40 sequentially numbered value cards that are numbered 1 through 10 inclusive and wherein there are four cards of each unique number and each card of each unique number is marked by a unique color, plus 6 action cards, wherein there are two each of three different actions.

6. The method of claim 1 wherein at the end of the game, if the value of the player hand is equal to the value of the dealer hand, the game is a draw and at least the player position ante wager is not forfeit.

7. The method of claim 1 wherein at the end of the game, if the value of the player hand is equal to the value of the dealer hand, the game is a draw and at least the player position ante wager is forfeit.

8. The method of claim 1 wherein at the end of the game, if the value of the player hand is more than to the value of the dealer hand, at least the player position ante wager is resolved by multiplying the said ante wager by the difference between the said values.

9. The method of claim 1 wherein at the end of the game, if the value of the player hand is less than to the value of the dealer hand, at least the player position ante wager is forfeit.

10. A casino video card game machine comprising: a housing; at least one display device; at least one processor; at least one physical input device configured to detect a physical item associated with a monetary amount that establishes a credit balance; at least an electronic input device; and at least one memory device which stores a plurality of instructions which, when executed by the at least one processor, cause the at least one processor to operate with the at least one display device and the at least one electronic input device to enable play of a casino video card game, comprising a predetermined number of randomized decks of virtual custom playing cards wherein each deck has fewer than 52 cards and wherein:
a) each custom deck of cards comprises a predetermined number of sequentially numbered value cards and a predetermined number of action cards fewer in number than the predetermined number of sequentially numbered value cards and action cards having game play directives thereon;
b) a lowest card of the sequentially numbered value cards are numbered cards having an alternate value of a highest card value +1;
c) each value card additionally has a casino video card game special marking;
d) each action card has no game value but rather indicates a casino video card game play directive;
the method performed when a player position makes an ante bet to play the casino video card game and receives one random card from the virtual custom deck of cards face up as an initial player position hand, and a dealer position then receives one random card from the virtual custom deck of cards face up as an initial dealer position hand, wherein:
e) if the first player position card is an action card, the action card is discarded and additional random cards are dealt to the player hand position until a value card is dealt to the player position hand;
f) the player position may I) stand, thereby not having an opportunity to draw additional cards and continue the casino video card game, or II) make a play wager in order to draw at least one additional random card from the virtual custom deck of cards;
g) if the player position has made the play wager, one additional card is dealt to the player position hand from the virtual custom deck of cards;
h) if the additional card is an equal-value or higher-value card compared to the first value card in the player position hand, or if the additional card matches the special marking of the first value card in the player position hand, the player position may choose or decline to draw a second additional card;
i) the player position may choose to keep drawing further additional cards if any additional card is a higher-valued card than the preceding value card in the player position hand, or if the special marking of the additional card matches the special marking of the said preceding value card in the player position hand;
j) if at any time after the first additional card the player position chooses not to draw any more additional cards, the player position stands and the value of the player hand is determined as the total number of cards in said hand;
k) if at any time an additional card has a lower value than the preceding card without matching the marking of the said preceding card, the player position hand busts and both the ante wager and the play wager are forfeit;
l) if at any time the player position is dealt an action card, the action card is set aside and does not become an element of the player position hand;
m) any directives of any dealt action card are mandatory and must be acted upon by the player, and the player position must still draw an additional card;
n) if at any time a first action card is immediately followed by another action card from the virtual custom deck of cards, only the another action card must be acted upon by the player, and the player must still draw an additional card;
o) if the player position does not bust and after the player stands, the dealer position hand is populated by additional cards until the dealer position hand busts by drawing a card from the virtual custom deck of cards that is lower than the preceding card and does not have the same marking as the said preceding card to the dealer position hand;
p) if any action card is dealt to the dealer position hand, the said action card is discarded and its game play directive is not acted upon by the dealer hand position;
q) upon the dealer position hand busting, the dealer position hand bust card is set aside, and the value of the dealer hand is the total of the number of cards in said hand without counting the bust card;
r) at least the ante wager is resolved by a difference between the value of the dealer hand and the value of the player hand; and
s) any winning wager may initiate a payout associated with the credit balance after an actuation of a cashout button is received.

11. The method of claim 10 wherein each sequentially numbered value card is marked by a color, a symbol or a pattern.

12. The method of claim 10 wherein an action card at least defines a play directive to: a) swap the last-dealt player card with the dealer up card; b) draw two mandatory cards; c) safely draw a card that cannot bust the player hand even if the said drawn card is lower than the previous card; d) reverse the order of the cards in the player hand; or e) double the play wager.

13. The method of claim 10 wherein the virtual custom deck of cards comprises 46 cards.

14. The method of claim 13 wherein there are 40 sequentially numbered value cards that are numbered 1 through 10 inclusive and wherein there are four cards of each unique number and each card of each unique number is marked by a unique color, plus 6 action cards, wherein there are two each of three different actions.

15. The method of claim 10 wherein at the end of the game, if the value of the player hand is equal to the value of the dealer hand, the game is a draw and at least the player position ante wager is not forfeit.

16. The method of claim 10 wherein at the end of the game, if the value of the player hand is equal to the value of the dealer hand, the game is a draw and at least the player position ante wager is forfeit.

17. The method of claim 10 wherein at the end of the game, if the value of the player hand is more than to the value of the dealer hand, at least the player position ante wager is resolved by multiplying the said ante wager by the difference between the said values.

18. The method of claim 10 wherein at the end of the game, if the value of the player hand is less than to the value of the dealer hand, at least the player position ante wager is forfeit.
